(19) United States
(12) Patent Application Publication
(10) Pub. No.: US 2013/0051679 A1
(43) Pub. Date: Feb. 28, 2013

(54) IMAGE PROCESSING APPARATUS AND IMAGE PROCESSING METHOD

(71) Applicants: Yoshiyuki Tsuda, Hirakata City (JP); Masayoshi Okamoto, Daito City (JP)

(72) Inventors: Yoshiyuki Tsuda, Hirakata City (JP); Masayoshi Okamoto, Daito City (JP)

(73) Assignee: SANYO ELECTRIC CO., LTD., Osaka (JP)

(21) Appl. No.: 13/571,506

(22) Filed: Aug. 10, 2012

(30) Foreign Application Priority Data
Aug. 25, 2011 (JP) 2011-183252

(51) Int. Cl. G06K 9/46

(52) U.S. Cl. 382/195

(57) ABSTRACT

An image processing apparatus includes a correction process portion which corrects a correction target region in an input image using an image signal in a region for correction, a detecting portion which detects a specified object region in which a specified type of object exists in the input image, and a setting portion which sets the region for correction based on positions of the correction target region and the specified object region.

### CROSS-REFERENCE TO RELATED APPLICATIONS

This nonprovisional application claims priority under 35 U.S.C. §119(a) on Patent Application No. 2011-183252 filed in Japan on Aug. 25, 2011, the entire contents of which are hereby incorporated by reference.

### BACKGROUND OF THE INVENTION

1. Field of the Invention

The present invention relates to an image processing apparatus and an image processing method for performing image processing.

2. Description of Related Art

There is a case where an unneeded object (a smudge or a mole on a face, or an electric wires in background) regarded as unnecessary by a user is depicted in a digital image, for example, which is obtained by photography using a digital camera. Concerning this, there is proposed an unneeded object elimination function for eliminating an unneeded object from an input image. In the unneeded object elimination function, the unneeded object elimination is realized by correcting an unneeded region specified by the user using an image signal in the periphery thereof For instance, an image signal in the unneeded region is replaced with an image signal in the periphery, or the image signal in the periphery is mixed to the image signal in the unneeded region, and hence the object in the unneeded region (namely, the unneeded object) can be eliminated from the input image.

In a first conventional method, random numbers are utilized so as to set a replacing pixel with respect to a pixel of interest specified by the user. Then, the pixel of interest is replaced with the replacing pixel in accordance with a luminance difference between the pixel of interest and the replacing pixel so that the unneeded object elimination is realized.

In addition, there is a second conventional method in which the entire image region of the input image is separated into a region of interest and an unneeded region based on edge intensity, and a rectangular region that does not include the unneeded region is clipped from the input image so that the unneeded object elimination is realized.

However, in the conventional methods including the first conventional method, the image signal to be used for correction is determined based on a simple criterion such as the random numbers and the luminance difference. Therefore, there is a possibility to perform an unnatural process of deforming contour of a person.

This is described with reference to FIGS. 11A to 11C. It is supposed that an input image 900 includes image signals of a person and a tree, and that an image region of the tree neighboring to a face of the person is set as an unneeded region 901. FIG. 11B illustrates a manner in which the unneeded region 901 is corrected by using pixels in the periphery of the unneeded region 901 (arrows in the diagram indicate a manner of replacement or mixing of image signals). In the conventional unneeded object elimination process, for example, based on luminance in a boundary between the unneeded region 901 and other region, the replacement or mixing of image signals is performed so that luminance in the vicinity of the boundary varies smoothly. As a result, an unnatural result image may be obtained as illustrated in FIG. 11C, in which the image signal in the face region is mixed into the unneeded region so that the face is extended to the unneeded region side. Although the problem that can occur in the conventional unneeded object elimination process is described above noting a face of a person, the same problem can occur in any object of interest other than a face of a person.

Note that if a main subject (person) and the unneeded object (tree) are close to each other like the input image 900, it is difficult to use the second conventional method (it is difficult to set the rectangular region that includes the main subject but does not include the unneeded object).

### SUMMARY OF THE INVENTION

An image processing apparatus according to the present invention includes a correction process portion which corrects a correction target region in an input image using an image signal in a region for correction, a detecting portion which detects a specified object region in which a specified type of object exists in the input image, and a setting portion which sets the region for correction based on positions of the correction target region and the specified object region.

An image processing method according to the present invention includes a correction process step of correcting a correction target region in an input image using an image signal in a region for correction, a detecting step of detecting a specified object region in which a specified type of object exists in the input image, and a setting step of setting the region for correction based on positions of the correction target region and the specified object region.

### BRIEF DESCRIPTION OF THE DRAWINGS

FIG. 1 is a schematic structure block diagram of an electronic apparatus according to an embodiment of the present invention.

FIG. 2 is an internal block diagram of an image correcting portion according to the embodiment of the present invention.

FIGS. 3A to 3D are diagrams illustrating an input image to the image correcting portion, and a face region and an unneeded region in the input image.

FIG. 4 is an action flowchart of an electronic apparatus according to a first example of the present invention.

FIG. 5 is a diagram illustrating an example of a mask region and a reference region in the input image according to the first example of the present invention.

FIG. 6A is a diagram illustrating a manner in which the unneeded region is corrected according to the first example of the present invention, and FIG. 6B is a diagram illustrating an output image according to the first example of the present invention.

FIG. 7 is an action flowchart of an electronic apparatus according to a second example of the present invention.

FIG. 8 is a diagram illustrating an example of the mask region and the reference region in the input image according to a second example of the present invention.

FIG. 9A is a diagram illustrating a manner in which the unneeded region is corrected according to the second example of the present invention, and FIG. 9B is a diagram illustrating an output image according to the second example of the present invention.

FIG. 10 is an action flowchart of an electronic apparatus according to a third example of the present invention.

FIGS. 11A to 11C are diagrams illustrating a conventional unneeded object elimination process.

### DETAILED DESCRIPTION OF THE PREFERRED EMBODIMENTS

Hereinafter, an example of an embodiment of the present invention is described specifically with reference to the attached drawings. In the drawings to be referred to, the same part is denoted by the same numeral or symbol so that overlapping description of the same part is omitted as a rule. Note that in this specification, for simple description, when a numeral or symbol represents information, a signal, physical quantity, state quantity, a member, or the like, a name of the information, the signal, the physical the quantity, the state quantity, the member, or the like corresponding to the numeral or symbol may be omitted or abbreviated.

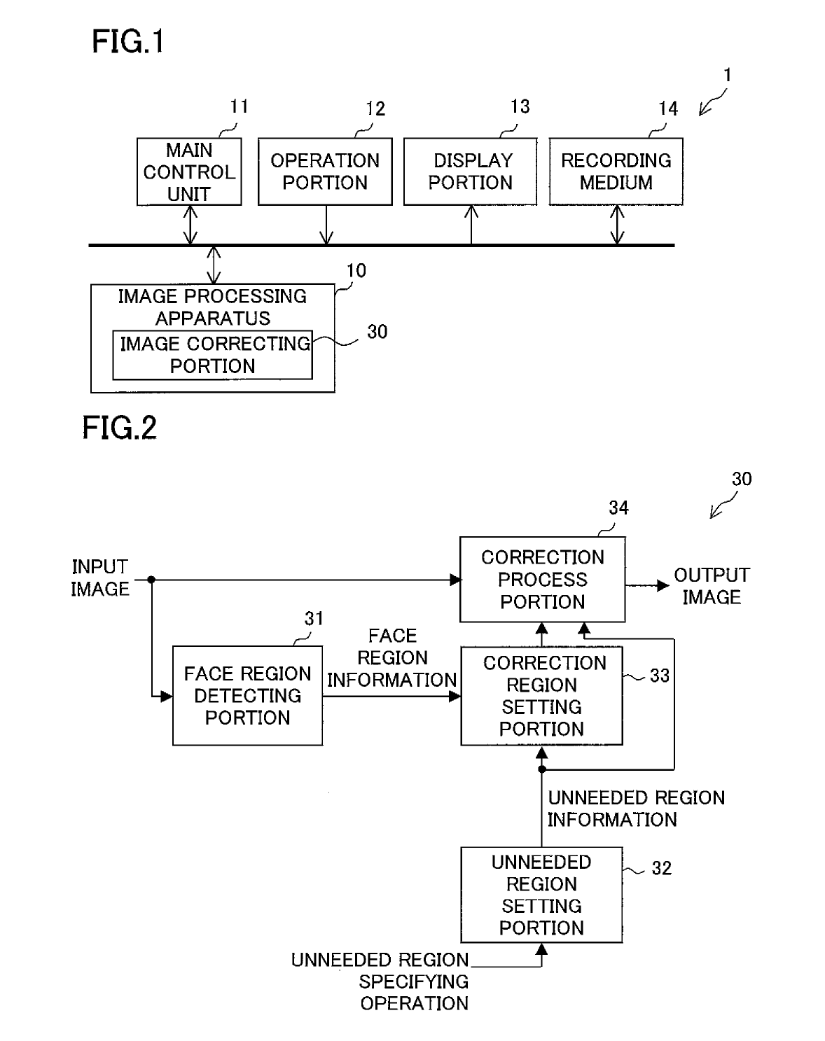

FIG. 1 is a schematic structure block diagram of an electronic apparatus 1 according to the embodiment of the present invention. The electronic apparatus 1 is an arbitrary electronic apparatus including an image processing apparatus 10 and is, for example, a digital still camera, a digital video camera, a personal computer, a mobile phone, or an information terminal The electronic apparatus 1 includes, in addition to the image processing apparatus 10, a main control unit 11 which integrally controls actions of individual portions of the electronic apparatus 1, an operation portion 12 which accepts inputs of various operations from the user, a display portion 13 which displays image information, and a recording medium 14 which records various types of information, and may further includes a necessary functional portion (such as a camera portion).

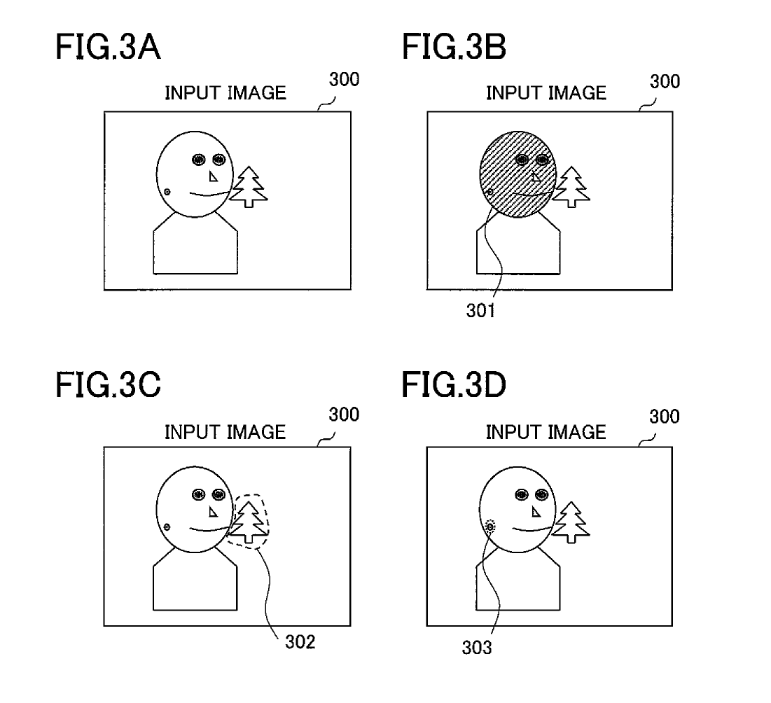

The image processing apparatus 10 includes an image correcting portion 30 which corrects the input image. FIG. 2 is an internal block diagram of the image correcting portion 30. The image correcting portion 30 includes individual portions denoted by numerals 31 to 34. The input image is a two-dimensional image read from the recording medium 14 or supplied externally of the electronic apparatus 1. An image 300 of FIG. 3A is an example the input image. The user can eliminate an object regarded as unnecessary by the user (hereinafter referred to as an unneeded object) from the input image using the image correcting portion 30. An image region where an image signal of the unneeded object exists is referred to as an unneeded region.

The face region detecting portion 31 detects and extracts a face region where an image signal of a human face exists from the entire image region of the input image based on an image signal of the input image, so as to generate and output face region information indicating a position, a size, and a shape of the face region on the input image. In FIG. 3B, a hatching region 301 is the face region in the input image 300. A method for detecting the face region is known, so detailed description thereof is omitted.

The unneeded region setting portion 32 sets the unneeded region on the input image based on an unneeded region specifying operation performed by the user to the electronic apparatus 1, so as to generate and output unneeded region information indicating a position, a size, and a shape of the unneeded region on the input image. In FIG. 3C, a region 302 surrounded by broken line is an example of the unneeded region on the input image 300. In this example, the unneeded object is a tree positioned close to the face. In FIG. 3D, a region 303 surrounded by broken line is another example of the unneeded region on the input image 300. In this example, the unneeded object is a mole or a smudge on the face. The unneeded region specifying operation may be an operation to the operation portion 12, or may be an operation to a touch panel that can be disposed on the display portion 13.

The correction region setting portion 33 sets the region for correction to be used for elimination of the unneeded object based on the face region information and the unneeded region information. The region for correction is an image region on the input image different from the unneeded region. For instance, a region adjacent to the unneeded region, which surrounds the unneeded region, may be the region for correction, or an image region that is not adjacent to the unneeded region may be the region for correction. A result of setting the correction region setting portion 33 is sent to the correction process portion 34 together with the unneeded region information.

The correction process portion 34 performs image processing for correcting the unneeded region using the image signal of the region for correction (hereinafter referred to as an unneeded object elimination process), so as to eliminate the unneeded object from the input image and generate an output image which is the input image after the elimination of the unneeded object. The electronic apparatus 1 can record the output image in the recording medium 14 and can display the same on the display portion 13. Arbitrary image processing for eliminating the unneeded object using an image signal of an image region other than the unneeded region can be used as the unneeded object elimination process. For instance, it is possible to eliminate the unneeded object by replacing an image signal of the unneeded region with the image signal of the region for correction, or the unneeded object may be eliminated by mixing the image signal of the region for correction to the image signal of the unneeded region. Note that the elimination may be complete elimination or may be partial elimination.

Hereinafter, as an example describing specific actions and the like of the electronic apparatus 1 and the image correcting portion 30, first to third examples are described. Description in one example can be applied to other example as long as no contradiction arises. In addition, in the following description, it is supposed that the input image is the input image 300 unless otherwise noted.

### First Example

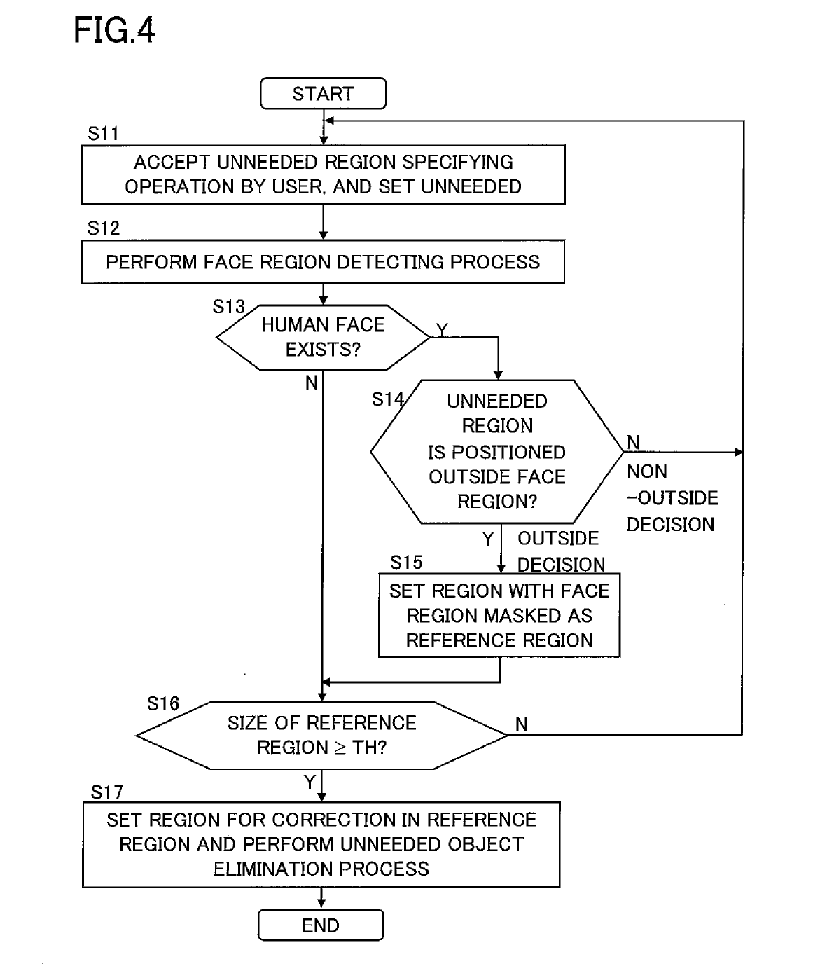

With reference to FIG. 4, a first example is described. FIG. 4 is an action flowchart of the electronic apparatus 1 according to the first example.

When the input image 300 is supplied to the image correcting portion 30, first in Step S11, the electronic apparatus 1 accepts the unneeded region specifying operation by the user, and the unneeded region setting portion 32 sets the unneeded region according to the unneeded region specifying operation. After the unneeded region is set, in Step S12, the face region detecting portion 31 performs a process for detecting the face region based on an image signal of the input image 300. In the next Step S13, it is checked whether or not a human face exists in the input image 300.

If a face exists in the input image 300 (namely, a face region is detected from the input image 300), the process goes from Step S13 to Step S14. In Step S14, the correction region setting portion 33 decides whether or not the unneeded region is positioned outside the face region based on the unneeded region information and the face region information (more specifically, based on a positional relationship between the unneeded region and the face region), so as to made an outside decision or a non-outside decision. If the entire unneeded region is positioned outside the face region, the outside decision is made. Otherwise, the non-outside decision is made. For instance, if the region 302 of FIG. 3C is the unneeded region, the outside decision is made.

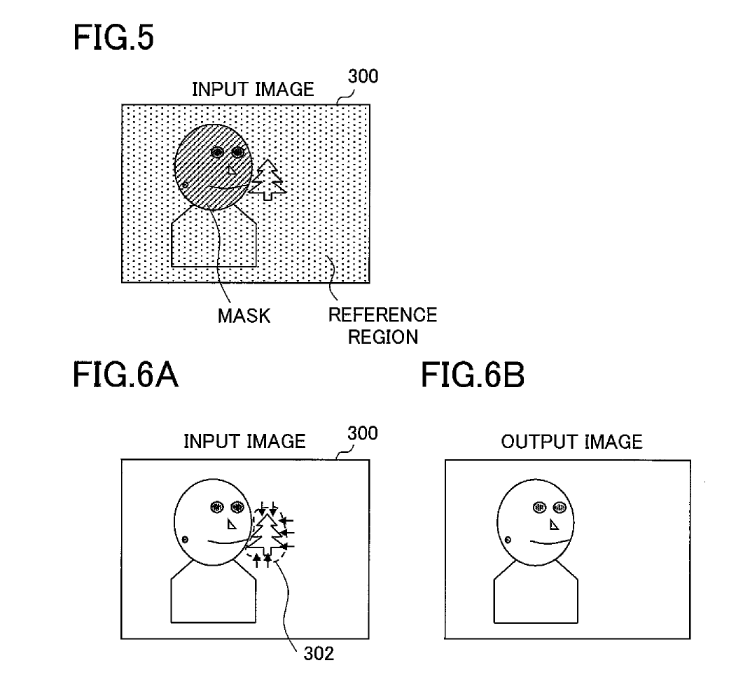

If the non-outside decision is made in Step S14, the process goes back to Step S11, and the electronic apparatus 1 accepts again the unneeded region specifying operation performed by the user (urges the user to specify the unneeded region again). On the other hand, if the outside decision is made in Step S14, the correction region setting portion 33 sets a region in which the face region 301 is masked, namely a region remained after removing the face region 301 from the input image 300, as the reference region in Step S15. In FIG. 5, a hatching region corresponds to a region to be masked, and a dotted region corresponds to the reference region. After that, in Step S16, the correction region setting portion 33 compares a size of the reference region with a predetermined threshold value TH. If the size of the reference region is the threshold value TH or larger, the process goes from Step S16 to Step S17. A size of the reference region is expressed by an area of the reference region or the number of pixels in the reference region. If a size of the reference region is smaller than the threshold value TH, it is decided that there is not sufficient region remained necessary for the unneeded object elimination, and the process goes back from Step S16 to Step S11.

In Step S17, the correction region setting portion 33 sets the region for correction in the reference region (extracts the region for correction suitable for elimination of the unneeded object from the reference region), and the correction process portion 34 performs the unneeded object elimination process using the image signal of the region for correction. FIG. 6A illustrates a case where the region 302 of FIG. 3C is set to the unneeded region and a manner in which the unneeded region 302 is corrected by using the image signal of the region for correction without the face region (arrows in the diagram illustrate a manner in which the image signal is replaced or mixed). FIG. 6B illustrates an example of the output image obtained in the case where the region 302 of FIG. 3C is set to the unneeded region.

Note that if it is decided in Step S13 that no face exists in the input image, the entire image region of the input image is set to the reference region, and the process goes to Step S17 via Step S16. In addition, if the non-outside decision is made in Step S14, it is possible to set the entire image region of the input image to the reference region so as to perform the process of Step S17 instead of going back to Step S11.

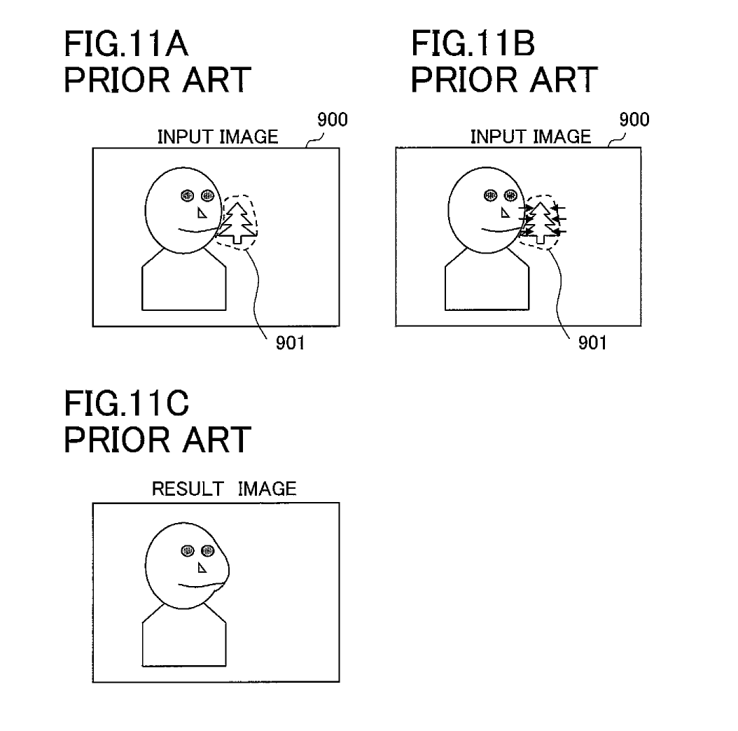

If the unneeded region is positioned outside the face region like the unneeded region 302 of FIG. 3C, and if the image signal of the unneeded region is corrected (replaced or mixed) using the image signal of the face region, an unnatural result image as illustrated in FIG. 11C may be obtained. In contrast, in the action example of FIG. 4, the unneeded region is corrected by using the image signal in the region where the face region is masked. Therefore, a natural output image can be obtained (it is possible to avoid unnaturalness in which the image signal of the face region 301 is mixed into the unneeded region 302 so that the face is extended to the unneeded region).

### Second Example

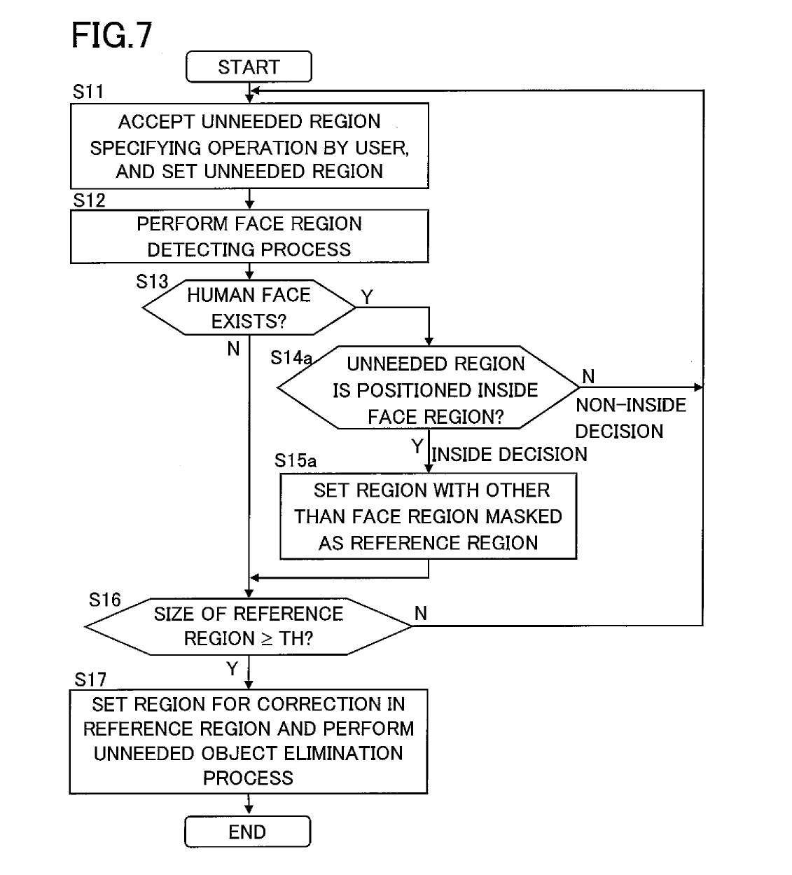

With reference to FIG. 7, a second example is described. FIG. 7 is an action flowchart of the electronic apparatus 1 according to the second example. The flowchart of FIG. 7 is obtained by replacing Steps S14 and S15 in the flowchart of FIG. 4 with Steps S14a and S15a. The processes of Steps S11 to S13, S16, and S17 in the flowchart of FIG. 7 are the same as those in the first example.

In the second example, if a face exists in the input image 300, the process goes from Step S13 to Step S14a. In Step S14a, the correction region setting portion 33 decides whether or not the unneeded region is positioned inside the face region based on the unneeded region information and the face region information (more specifically, based on a positional relationship between the unneeded region and the face region), so as to made an inside decision or a non-inside decision. If the entire unneeded region is positioned inside the face region, the inside decision is made. Otherwise, the non-inside decision is made. For instance, if the region 303 of FIG. 3D is the unneeded region, the inside decision is made.

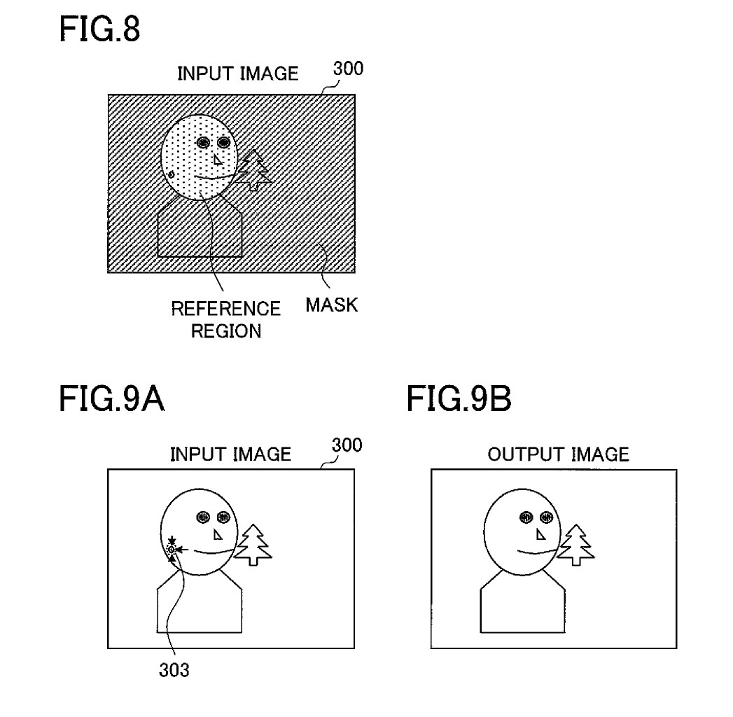

If the non-inside decision is made in Step S14a, the process goes back to Step S11, and the electronic apparatus 1 accepts again the unneeded region specifying operation performed by the user (urges the user to specify the unneeded region again). On the other hand, if the inside decision is made in Step S14a, the correction region setting portion 33 sets a region in which other than the face region 301 is masked as the reference region, namely sets the face region 301 as the reference region in Step S15a. In FIG. 8, a hatching region corresponds to a region to be masked, and a dotted region corresponds to the reference region. After the process of Step S15a, similarly to the first example, the process of Steps S16 and S17 is performed.

FIG. 9A illustrates a case where the region 303 of FIG. 3D is set to the unneeded region and a manner in which the unneeded region 303 is corrected by using the image signal of the face region (arrows in the diagram illustrate a manner in which the image signal is replaced or mixed). FIG. 9B illustrates an example of the output image obtained in the case where the region 303 of FIG. 3D is set to the unneeded region. Note that if the non-inside decision is made in Step S14a, it is possible to set the entire image region of the input image to the reference region so as to perform the process of Step S17 instead of going back to Step S11 (the same is true for a third example described later).

If the region 303 of FIG. 3D is set to the unneeded region, the unneeded region exists inside the face region. In this case, if the unneeded object elimination process is performed by using the image signal of a region other than the face region (for example, the image signal of the background), an unnatural result image may be obtained (for example, the image signal of the background is mixed into the face region of the output image). In contrast, in the action example of FIG. 7, because the image signal of the unneeded region in the face region is corrected by using the image signal in the face region, a natural output image can be obtained.

### Third Example

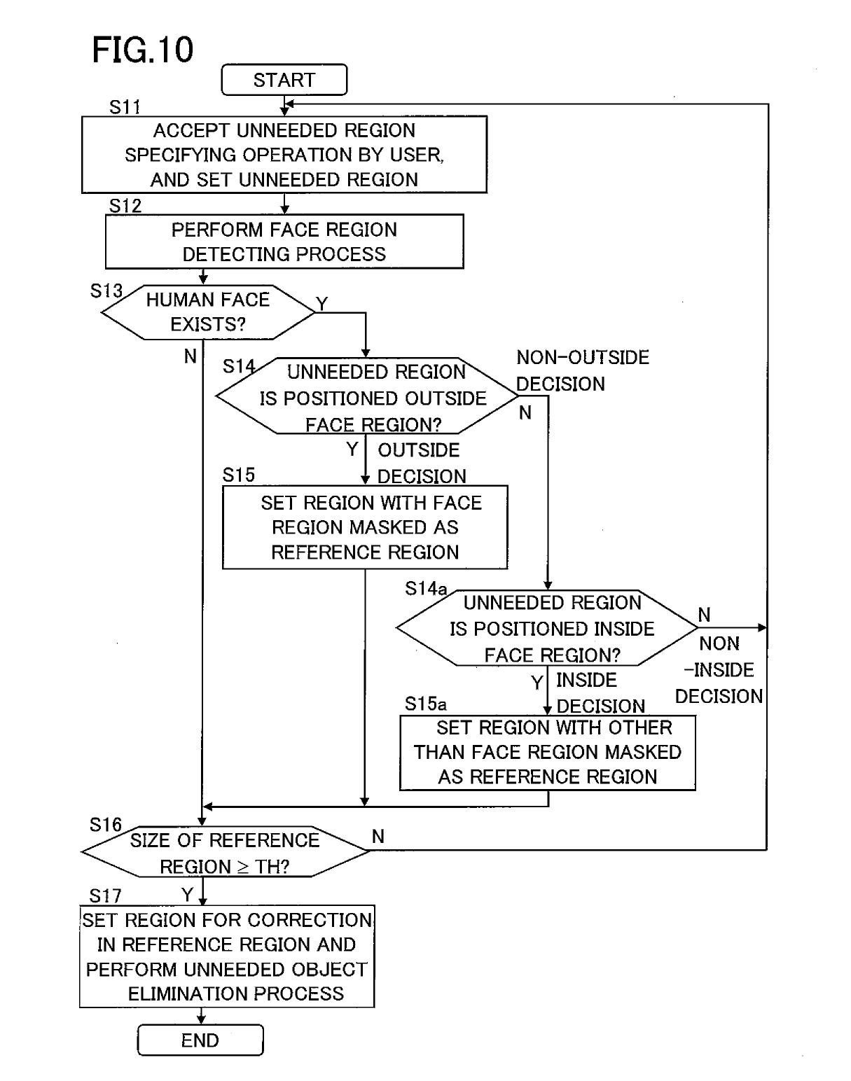

A third example is described. In the first and second examples described above, it can be said that the correction region setting portion 33 decides whether or not to use the image signal in the face region as the image signal of the region for correction based on the positional relationship between the unneeded region and the face region (based on whether or not the unneeded region is outside the face region, or based on whether or not the unneeded region is inside the face region). It is possible to combine the above-mentioned first and second examples. FIG. 10 is an action flowchart of the electronic apparatus 1 in which this combination is made.

The flowchart of FIG. 10 is obtained by adding Steps S14a and S15a of FIG. 7 to Steps S11 to S17 of FIG. 4, and basic action thereof is the same as that of the first example (FIG. 4). Hereinafter, different points from the first example (FIG. 4) are described.

In the third example corresponding to FIG. 10, if the non-outside decision is made in Step S14, the process goes to Step S14a. In Step S14a, the correction region setting portion 33 decides whether or not the unneeded region is positioned inside the face region based on the unneeded region information and the face region information (more specifically, based on a positional relationship between the unneeded region and the face region), so as to made an inside decision or a non-inside decision. If the non-inside decision is made in Step S14a, the process goes back to Step S11, and the electronic apparatus 1 receives again the unneeded region specifying operation performed by the user (urges the user to specify the unneeded region again). On the other hand, if the inside decision is made in Step S14a, the correction region setting portion 33 sets the region in which other than the face region 301 is masked as the reference region in Step S15a, namely sets the face region 301 as the reference region. After the process of Step S15a, the process of Steps S16 and S17 is performed similarly to the first example.

<<Variations>>

The embodiment of the present invention can be appropriately changed variously within the technical concept described in the claims. The embodiment described above is merely an example of the embodiment of the present invention, meanings of the present invention and elements thereof are not limited to those described above in the embodiment. As annotations that can be applied to the above-mentioned embodiment, Note 1 and Note 2 are described below. The descriptions in the Notes can be combined arbitrarily as long as no contradiction arises.

[Note 1]

In the embodiment described above, the correction process is performed by regarding the unneeded region as the correction target region. In this case, the face region is detected as the specified object region in which the specified type of object exists, and the region for correction is set by using the position of the face region. The human face is an example of the specified type of object, and the face region detecting portion 31 is an example of the specified object region detecting portion. The specified type of object may be other than the human face. An arbitrary object having a specified contour (for example, a face of an animal as a pet) may be the specified type of object.

[Note 2]

The image correcting portion 30 may be constituted of hardware or a combination of hardware and software. The functions of the image correcting portion 30 may be realized by using image processing software running on the electronic apparatus 1 for general purpose. In other words, it is possible to describe the actions executed by the image correcting portion 30 as a program, and to make the electronic apparatus 1 execute the program so as to realize the function of the image correcting portion 30.

What is claimed is:

1. An image processing apparatus comprising:
a correction process portion which corrects a correction target region in an input image using an image signal in a region for correction;
a detecting portion which detects a specified object region in which a specified type of object exists in the input image; and
a setting portion which sets the region for correction based on positions of the correction target region and the specified object region.

2. The image processing apparatus according to claim 1, wherein the setting portion determines whether or not to use an image signal in the specified object region as the image signal in the region for correction based on a positional relationship between the correction target region and the specified object region.

3. The image processing apparatus according to claim 2, wherein the setting portion sets the region for correction in an image region other than the specified object region in the input image when the correction target region is positioned outside the specified object region.

4. The image processing apparatus according to claim 2, wherein the setting portion sets the region for correction in the specified object region within the input image when the correction target region is positioned inside the specified object region.

5. The image processing apparatus according to claim 1, wherein the specified type of object includes a human face.

6. An image processing method comprising:
a correction process step of correcting a correction target region in an input image using an image signal in a region for correction;
a detecting step of detecting a specified object region in which a specified type of object exists in the input image; and
a setting step of setting the region for correction based on positions of the correction target region and the specified object region.
